(19) United States
(12) Patent Application Publication
(10) Pub. No.: US 2022/0277480 A1
(43) Pub. Date: Sep. 1, 2022

(54) POSITION ESTIMATION DEVICE, VEHICLE, POSITION ESTIMATION METHOD AND POSITION ESTIMATION PROGRAM

(71) Applicant: PANASONIC INTELLECTUAL PROPERTY MANAGEMENT CO., LTD., Osaka (JP)

(72) Inventors: Takafumi TOKUHIRO, Kanagawa (JP); Zheng WU, Singapore (SG); Pongsak LASANG, Singapore (SG)

(73) Assignee: PANASONIC INTELLECTUAL PROPERTY MANAGEMENT CO., LTD., Osaka (JP)

(21) Appl. No.: 17/748,803

(22) Filed: May 19, 2022

Related U.S. Application Data
(63) Continuation of application No. PCT/JP2020/042593, filed on Nov. 16, 2020.

(30) Foreign Application Priority Data
Nov. 22, 2019 (JP) 2019-211243

(51) Int. Cl. G06T 7/73; H04N 5/247

(52) U.S. Cl. CPC G06T 7/74; H04N 5/247; G06T 2207/30244; G06T 2207/30252

(57) ABSTRACT

This position estimation device of a moving body with n cameras for imaging the surrounding scene is provided with: an estimation unit which, for each of the n cameras, calculates a camera candidate position in a map space on the basis of the camera image position of a feature point in the scene extracted from the camera image and the map space position of said feature point pre-stored in the map data; and a verification unit which, with reference to said candidate positions, projects onto the camera image of each of the n cameras a feature point cloud in the scene stored in the map data, and calculates the accuracy of the candidate positions of the n cameras on the basis of the matching degree between the feature point cloud projected onto the camera image and a feature point cloud extracted from the camera images.

### TECHNICAL FIELD

The present disclosure relates to a position estimation apparatus, a vehicle, a position estimation method, and a position estimation program.

### BACKGROUND ART

Position estimation apparatuses (also referred to as self-position estimation apparatuses) have been conventionally known which are mounted on mobile bodies such as vehicles or robots and estimate positions and postures of the mobile bodies, by using cameras provided to the mobile bodies (e.g., see Non-Patent Literature (hereinafter referred to as “NPL”)1 and NPL 2).

This type of position estimation apparatus typically refers to map data for storing three-dimensional positions of feature points (also referred to as landmarks) of an object present in a previously-generated actual view (which refers to a view that can be captured by a camera around a mobile body, the same applies hereinafter), associates feature points captured in a camera image and the feature points in the map data with each other, and thereby performs processing of estimating a position and a posture of the camera (i.e., a position and a posture of the mobile body).

### CITATION LIST

### Patent Literatures

### NPL 1

Mikael Persson et al. “Lambda Twist: An Accurate Fast Robust Perspective Three Point (P3P) Solver.”, ECCV 2018, pp 334-349, published in 2018, http://openaccess.thecvf.com/content_ECCV_2018/papers/Mikael_Persson_Lambda_Twist_An_ECCV_2018_paper.pdf

### NPL 2

Gim Hee Lee et al “Minimal Solutions for Pose Estimation of a Multi-Camera System”, Robotics Research pp 521-538, published in 2016, https://inf.ethz.ch/personal/pomarc/pubs/LeeiSRR13.pdf

### SUMMARY OF INVENTION

The present disclosure is directed to providing a position estimation apparatus, a vehicle, a position estimation method, and a position estimation program each capable of improving the estimation accuracy for a position and a posture of a mobile body with a small computation load.

### Solution to Problem

A position estimation apparatus according to an aspect of the present of the present disclosure is for a mobile body including n cameras (where n is an integer of two or more) for capturing an actual view of surroundings, the position estimation apparatus including:

an estimator that calculates a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and

a verifier that projects feature point groups in the actual view onto camera images respectively taken by the n cameras, with reference to the candidate position of the k-th camera, the feature point groups being stored in the map data in association with the positions in the map space, and calculates a precision degree of the candidate position of the k-th camera based on matching degrees between the feature point groups projected onto the camera images respectively taken by the n cameras and the feature point groups extracted respectively from the camera images taken by the n cameras.

wherein:

the estimator calculates the candidate position for each of first to n-th cameras of the n cameras,

the verifier calculates the precision degree of the candidate position of each of the first to n-th cameras of the n cameras, and

a position of the mobile body is estimated with reference to the candidate position having a highest precision degree among a plurality of the precision degrees of the candidate positions of the first to n-th cameras of the n cameras.

Further, a vehicle according to another aspect of the present disclosure includes the position estimation apparatus.

Further, a position estimation method according to another aspect of the present disclosure is for a mobile body including n cameras (where n is an integer of two or more) for capturing an actual view of surroundings, the position estimation method including:

calculating a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and

projecting feature point groups in the actual view onto camera images respectively taken by the n cameras, with reference to the candidate position of the k-th camera, the feature point groups being stored in the map data in association with the positions in the map space, and calculating a precision degree of the candidate position of the k-th camera based on matching degrees between the feature point groups projected onto the camera images respectively taken by the n cameras and the feature point groups extracted respectively from the camera images taken by the n cameras,

wherein:

in the calculating of the candidate position, the candidate position is calculated for each of first to n-th cameras of the n cameras,

in the projecting of the feature point groups and the calculating of the precision degree, the precision degree of the candidate position of each of the first to n-th cameras of the n cameras is calculated, and

a position of the mobile body is estimated with reference to the candidate position having a highest precision degree among a plurality of the precision degrees of the candidate positions of the first to n-th cameras of the n cameras.

Further, a position estimation program according to another aspect of the present disclosure causes a computer to estimate a position of a mobile body including n cameras (where n is an integer of two or more) for capturing an actual view of surroundings, the position estimation program including:

calculating a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and

projecting feature point groups in the actual view onto camera images respectively taken by the n cameras, with reference to the candidate position of the k-th camera, the feature point groups being stored in the map data in association with the positions in the map space, and calculating a precision degree of the candidate position of the k-th camera based on matching degrees between the feature point groups projected onto the camera images respectively taken by the n cameras and the feature point groups extracted respectively from the camera images taken by the n cameras,

wherein:

in the calculating of the candidate position, the candidate position is calculated for each of first to n-th cameras of the n cameras,

in the projecting of the feature point groups and the calculating of the precision degree, the precision degree of the candidate position of each of the first to n-th cameras of the n cameras is calculated, and

a position of the mobile body is estimated with reference to the candidate position having a highest precision degree among a plurality of the precision degrees of the candidate positions of the first to n-th cameras of the n cameras.

### BRIEF DESCRIPTION OF DRAWINGS

FIG. 1 illustrates a configuration example of a vehicle according to an embodiment:

FIG. 2 illustrates examples of mounting positions of four cameras mounted on the vehicle according to the embodiment;

FIG. 3 illustrates an exemplary hardware configuration of a position estimation apparatus according to the embodiment;

FIG. 4 illustrates an example of map data previously stored in the position estimation apparatus according to the embodiment:

FIG. 5 illustrates a configuration example of the position estimation apparatus according to the embodiment:

FIG. 6 illustrates exemplary feature points extracted by the first feature point extractor according to the embodiment;

FIG. 7 is a diagram for describing processing of the first estimator according to the embodiment;

FIG. 8 is a diagram for describing processing of the first verifier according to the embodiment.

FIG. 9 is another diagram for describing processing of the first verifier according to the embodiment;

FIG. 10 is a flowchart illustrating an exemplary operation of the position estimation apparatus according to the embodiment;

FIG. 11 schematically illustrates loop processing in steps Sa and Sb of FIG. 10; and

FIG. 12 is a flowchart illustrating an exemplary operation of a position estimation apparatus according to a variation.

### DESCRIPTION OF EMBODIMENTS

Conventionally, as in NPL 1, this type of position estimation apparatus adopts a method in which three feature points are extracted from a plurality of feature points captured in a camera image taken by a single camera (may be referred to as a “camera image of the (single) camera”), and a candidate position and a candidate posture of the camera are calculated based on positions of the three feature points in an imaging plane of the camera image and three-dimensional positions of the three feature points stored in map data. In this method, the optimal solution of the position and posture of the camera is calculated by performing a repetitive operation while changing feature points to be extracted from the camera image (also referred to as Random Sample Consensus (RANSAC)).

This conventional technology is advantageous in estimating the position and posture of the mobile body with a relatively small computation load; however, it has a problem in that the estimation accuracy is deteriorated when a distribution of the feature points captured in the camera image is greatly different from a distribution of the feature points stored in the map data due to the effect of occlusion (indicating a state where an object in the foreground hides an object behind thereof from view) or the like.

With this background, for example, as in NPL 2, a method has been discussed of improving the robustness against the occlusion, using a plurality of cameras. However, in this method, it is generally required to simultaneously solve geometric computations of 3D-2D geometric operations in the camera images of the respective cameras, which involves a huge computation amount (e.g., it is required to solve an eighth order polynomial). Incidentally, in a case where the computation amount becomes huge as described above, particularly in an environment where computation performance is limited, such as an on-vehicle environment, a computation of position estimation is not performed in time with respect to a movement speed of the mobile body, and thus, the estimation accuracy is substantially deteriorated.

The position estimation apparatus according to the present disclosure enables the position estimation and the posture estimation of a mobile body which eliminate such problems.

Hereinafter, for convenience of description, the term “position” includes both concepts of “position” and “posture (i.e., orientation)” of a camera or a mobile body.

Preferred embodiments of the present disclosure will be described in detail with reference to the attached drawings. Note that, elements having substantially the same functions are assigned the same reference numerals in the description and drawings to omit duplicated descriptions thereof.

[Configuration of Vehicle]

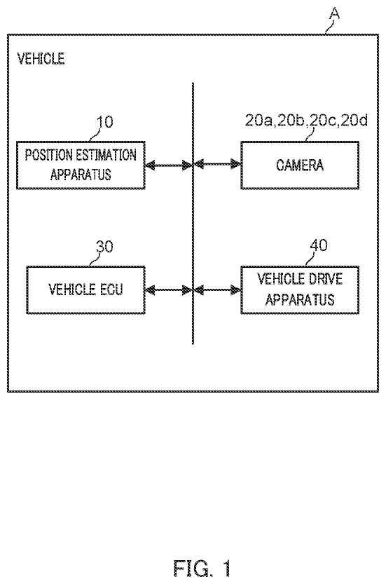

Hereinafter, an exemplary overview configuration of a position estimation apparatus according to an embodiment will be described with reference to FIGS. 1 to 4. The position estimation apparatus according to the present embodiment is mounted on a vehicle and estimates a position of the vehicle. In the following, for convenience of description, the term “position” includes both the concepts of “position” and “posture (i.e., orientation)” of the camera or the mobile body.

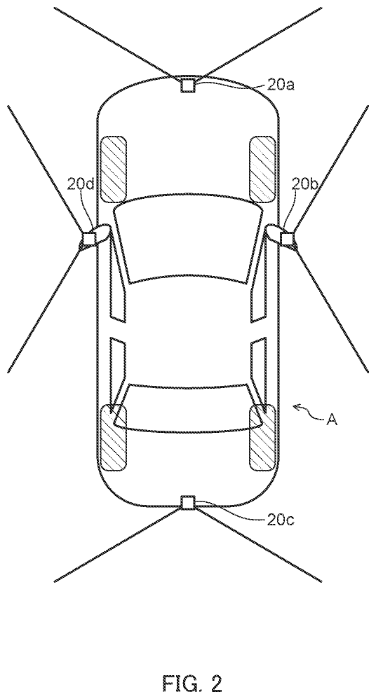

FIG. 1 illustrates a configuration example of vehicle A according to the present embodiment. FIG. 2 illustrates examples of mounting positions of four cameras 20a, 20b, 20c, and 20d which are mounted on vehicle A according to the present embodiment.

Vehicle A includes position estimation apparatus 10, four cameras 20a, 20b, 20c, and 20d (hereinafter also referred to as “first camera 20a.” “second camera 20b,” “third camera 20c,” and “fourth camera 20d”), vehicle ECU 30, and vehicle drive apparatus 40.

First to fourth cameras 20a to 20d are, for example, general-purpose visible cameras for capturing an actual view around vehicle A, and perform AD conversion on image signals generated by their own imaging elements so as to generate image data D1, D2, D3, and D4 according to camera images (hereinafter, referred to as “camera image data”). Note that, camera image data D1, D2, D3, and D4 are temporally synchronized. First to fourth cameras 20a to 20d then output the camera image data generated by themselves to position estimation apparatus 10. Incidentally, first to fourth cameras 20a to 20d are configured to, for example, continuously perform imaging and to be capable of generating the camera image data in a moving image format.

First to fourth cameras 20a to 20d are arranged to capture areas different from each other. Specifically, first camera 20a is placed on a front face of vehicle A to capture a front area of vehicle A. Second camera 20b is placed on the right side mirror of vehicle A to capture a right side area of vehicle A. Third camera 20c is placed on a rear face of vehicle A to capture a rear area of vehicle A. Fourth camera 20d is placed on the left side mirror of vehicle A to capture a left side area of vehicle A.

Position estimation apparatus 10 estimates a position of vehicle A (e.g., three-dimensional position of vehicle A in a world-coordinate system and orientation of vehicle A) based on the camera image data of first to fourth cameras 20a to 20d. Position estimation apparatus 10 then transmits information relating to the position of vehicle A to vehicle ECU 30.

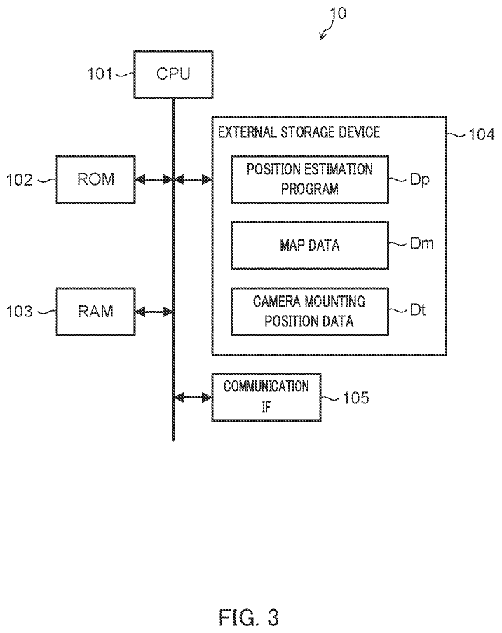

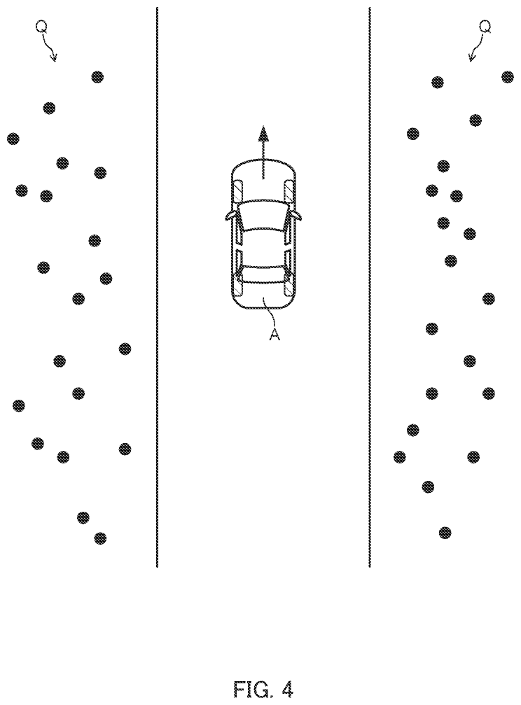

FIG. 3 illustrates an exemplary hardware configuration of position estimation apparatus 10 according to the present embodiment. FIG. 4 illustrates an example of map data Dm previously stored in position estimation apparatus 10 according to the present embodiment. In FIG. 4, positions on a map space of a plurality of feature points Q in the actual view stored in map data Dm are illustrated by a bird's-eye view.

Position estimation apparatus 10 is a computer including Central Processing Unit (CPU) 101, Read Only Memory (ROM) 102, Random Access Memory (RAM) 103, external storage device (e.g., flash memory) 104, and communication interface 105 as main components.

Position estimation apparatus 10 implements the functions described below by, for example, CPU 101 referring to a control program (e.g., position estimation program Dp) and various kinds of data (e.g., map data Dm and camera mounting position data Dt) that are stored in ROM 102, RAM 103, external storage device 104, and the like.

External storage device 104 of position estimation apparatus 10 stores map data Dm and camera mounting position data Dt, in addition to position estimation program Dp for performing position estimation of vehicle A to be described later.

With respect to each of the plurality of feature points in the actual view obtained previously in a wide area (including an area around vehicle A), map data Dm stores a three-dimensional position of the feature point in the map space and a feature amount of the feature point obtained from the camera image captured at the time of generating map data Dm in association with each other. The feature point stored as map data Dm is, for example, a portion (e.g., a corner portion) where a characteristic image pattern is obtained from a camera image of an object that may be a mark in the actual view (e.g., building, sign, signboard, or the like). Further, as the feature point in the actual view, a feature point of a marker installed in advance may be used. Note that, a plurality of feature points on map data Dm are stored identifiable from each other by, for example, an identification number.

The three-dimensional position of the feature point stored in map data Dm in the map space (which refers to a space represented by a three-dimensional coordinate system in map data Dm: the same applies hereinafter) is represented by a three-dimensional orthogonal coordinate system (X, Y, Z). Incidentally, these coordinates (X, Y, Z) may be associated with, for example, the coordinates on a real space such as latitude, longitude, and altitude. This makes the map space synonymous with the real space. Incidentally, the three-dimensional position of the feature point in the map space is a position previously obtained by, for example, a measurement using camera images captured at a plurality of positions (e.g., measurement using the principle of triangulation), a measurement using Light Detection and Ranging (LIDAR), or a measurement using a stereo camera.

As the feature amount of the feature point stored in map data DM, in addition to brightness and density on the camera image, a Scale Invariant Feature Transform (SIFT) feature amount, a Speeded Up Robust Features (SURF) feature amount, or the like is used. Incidentally, feature amount data of the feature point stored in map data Dm may be stored separately for each capturing position and capturing direction of the camera when the feature point is captured even for the feature point of the same three-dimensional position. Further, the feature amount data of the feature point stored in map data Dm may be stored in association with an image of an object having the feature point.

Camera mounting position data Dt stores a mutual positional relationship between first to fourth cameras 20a to 20d (e.g., relationship concerning a distance between the cameras, and relationship concerning orientations of the cameras). In other words, the positions of respective first to fourth cameras 20a to 20d can be calculated by specifying a positon of any one of the cameras.

Camera mounting position data Dt also stores a positional relationship between the respective positions of first to fourth cameras 20a to 20d and a predetermined position of vehicle A (e.g., the center of gravity) so that vehicle A can be specified from the respective positions of first to fourth cameras 20a to 20d.

Vehicle (Electronic Control Unit) ECU 30 is an electronic control unit for controlling vehicle drive apparatus 40. For example, vehicle ECU 30 automatically controls each part of vehicle drive apparatus 40 (e.g., output of drive motor, connection/disconnection of clutch, speed shifting stage of automatic transmission, and steering angle of steering device) so that a traveling condition of vehicle A is optimized, while referring to the position of vehicle A estimated by position estimation apparatus 10.

Vehicle drive apparatus 40 is a driver for driving vehicle A and includes, for example, a drive motor, an automatic transmission, a power transmission mechanism, a braking mechanism, and a steering device. Incidentally, operations of vehicle drive apparatus 40 according to the present embodiment are controlled by vehicle ECU 30.

Incidentally, position estimation apparatus 10, first to fourth cameras 20a to 20d, vehicle ECU 30, and vehicle drive apparatus 40 are connected to each other via an on-vehicle network (e.g., communication network conforming to CAN communication protocol) and can transmit and receive necessary data and control signals to and from each other.

[Detailed Configuration of Position Estimation Apparatus]

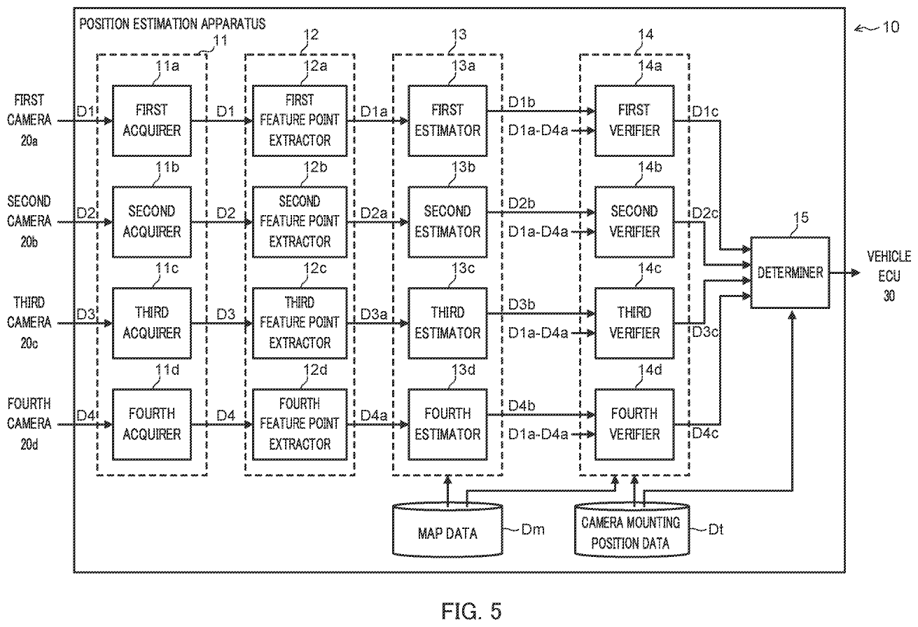

Next, with reference to FIGS. 5 to 9, a detailed configuration of position estimation apparatus 10 according to the present embodiment will be described.

FIG. 5 illustrates a configuration example of position estimation apparatus 10 according to the present embodiment.

Position estimation apparatus 10 includes acquirer 11, feature point extractor 12, estimator 13, verifier 14, and determiner 15.

Acquirer 11 acquires camera image data D1 to D4 respectively from first to fourth cameras 20a to 20d that are mounted on vehicle A. Specifically, acquirer 11 includes first acquirer 11a that acquires camera image data D1 from first camera 20a, second acquirer 11b that acquires camera image data D2 from second camera 20b, third acquirer 11c that acquires camera image data D3 from third camera 20c, and fourth acquirer 11d that acquires camera image data D4 from fourth camera 20d. Camera image data D1 to D4 acquired respectively by first to fourth acquirers 11a to 11d are generated at the same time.

Feature point extractor 12 extracts feature points in the actual views from the respective camera images for camera image data D1 to D4. Specifically, feature point extractor 12 includes first feature point extractor 12a that extracts a feature point in the actual view from the camera image of first camera 20a, second feature point extractor 12b that extracts a feature point in the actual view from the camera image of second camera 20b, third feature point extractor 12c that extracts a feature point in the actual view from the camera image of third camera 20c, and fourth feature point extractor 12d that extracts a feature point in the actual view from the camera image of fourth camera 20d. Note that, first to fourth extractors 12a to 12d may be implemented by four processors provided separately or by time-dividing processing time with a single processor.

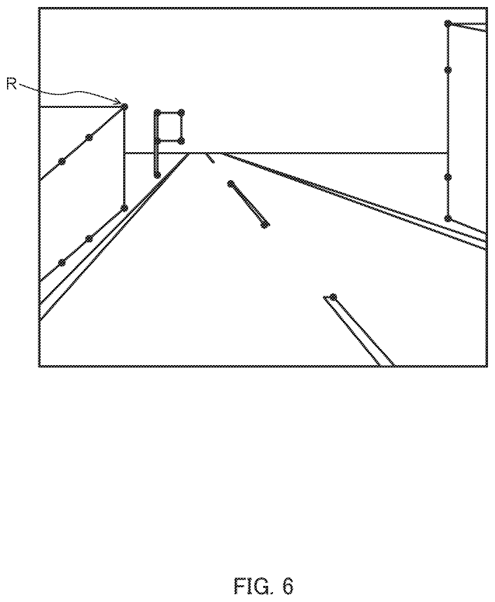

FIG. 6 illustrates exemplary feature points extracted by first feature point extractor 12a according to the present embodiment. FIG. 6 illustrates an exemplary camera image generated by first camera 20a, in which corners or the like of objects captured in the camera image are extracted as feature points R.

The technique by which first to fourth feature point extractors 12a to 12d extract feature points from the camera images may be any publicly known technique. First to fourth extractors 12a to 12d extract feature points from the camera images by using, for example, a SIFT method, a Harris method, a FAST method, or learned Convolutional Neural Network (CNN).

Data D1a to D4a of the feature points extracted from the respective camera images taken by first to fourth cameras 20a to 20d (may be referred to as “camera images of first to fourth cameras 20a to 20d”) include, for example, two-dimensional coordinates of the feature points in the camera images and feature amount information on the feature points.

Estimator 13 calculates candidates for positions where first to fourth cameras 20a to 20d are present respectively. Specifically, estimator 13 includes first estimator 13a that calculates a candidate position of first camera 20a (hereinafter also referred to as “first candidate position”) based on feature point data D1a of the camera image of first camera 20a and map data Dm, second estimator 13b that calculates a candidate position of second camera 20b (hereinafter also referred to as “second candidate position”) based on feature point data D2a of the camera image of second camera 20b and map data Dm, third estimator 13c that calculates a candidate position of third camera 20c (hereinafter also referred to as “third candidate position”) based on feature point data D3a of the camera image of third camera 20c and map data Dm, and fourth estimator 13d that calculates a candidate position of fourth camera 20d (hereinafter also referred to as “fourth candidate position”) based on feature point data D4a of the camera image of fourth camera 20d and map data Dm. Incidentally, estimator 13 may, instead of calculating candidate positions of the respective cameras by using first to fourth estimators 13a to 13d respectively corresponding to first to fourth cameras 20a to 20d, time-divide processing time of estimator 13 to calculate candidate positions of the respective cameras.

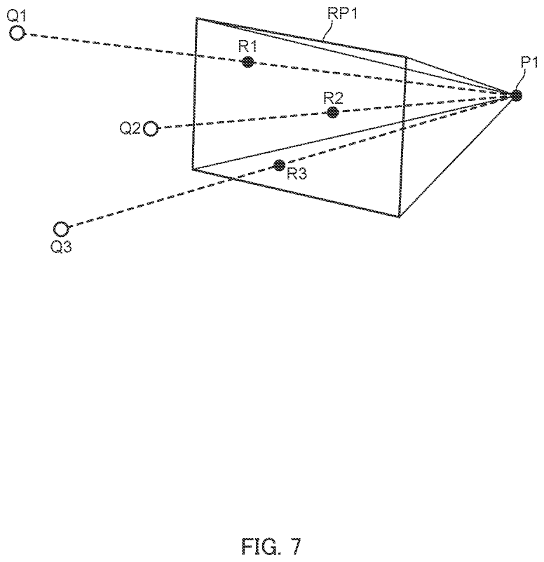

FIG. 7 is a diagram for describing processing of first estimator 13a according to the present embodiment. Points R1, R2, and R3 in FIG. 7 represent three feature points extracted from the camera image of first camera 20a, and points Q1, Q2, and Q3 represent three-dimensional positions on the map space of feature points R1, R2, and R3 that are stored in map data Dm. Further, point P1 represents a candidate position of first camera 20a. RP1 represents an imaging plane of first camera 20a.

First estimator 13a first matches the feature points extracted from the camera image of first camera 20a with the feature points stored in map data Dm by means of pattern matching, feature amount search, and/or the like. First estimator 13a then randomly selects several (e.g., three to six) feature points from among all the feature points that have been extracted from the camera image of first camera 20a and that have been successfully matched with the feature points stored in map data Dm, and calculates the first candidate position of first camera 20a based on positions of these several feature points in the camera image (e.g., points R1, R2, and R3 in FIG. 7) and three-dimensional positions of these several feature points stored in map data Dm (e.g., points Q1, Q2, and Q3 in FIG. 7). At this time, first estimator 13a calculates the first candidate position of first camera 20a by solving a PnP problem by using, for example, a known technique such as Lambda Twist (see, for example, NPL 1).

Incidentally, when matching the feature points extracted from the camera image of first camera 20a with the feature points stored in map data Dm, first estimator 13a may narrow down, among the feature points stored in map data Dm, feature points to be matched with the feature points extracted from the camera image of first camera 20a, with reference to a current position of vehicle A estimated from Global Positioning System (GPS) signals or a position of vehicle A calculated in a previous frame.

The number of feature points used by first estimator 13a for calculating the first candidate position of first camera 20a is preferably set to three. Thus, it is possible to reduce the computation load of calculating the first candidate position.

Meanwhile, in order to calculate the first candidate position with higher accuracy, first estimator 13a preferably calculates a plurality of first candidate positions by repeatedly changing feature points used for calculating the first candidate position among all the feature points extracted from the camera image of first camera 20a. Note that, in a case where a plurality of the first candidate positions is calculated in first estimator 13a, a degree of precision (hereinafter may be also referred to as precision degree) for each of the plurality of first candidate positions is calculated in first verifier 14a to be described later.

Second estimator 13b, third estimator 13c, and fourth estimator 13d respectively calculate, by using the same technique as in first estimator 13a, the second candidate position of second camera 20b, third candidate position of third camera 20c, and fourth candidate position of fourth camera 20d.

Incidentally, the respective candidate positions of first to fourth cameras 20a to 20d are represented by, for example, three-dimensional positions in the world coordinate system (X coordinate, Y coordinate, Z coordinate) and capturing directions of the cameras (roll, pitch, yaw).

Data D1b of the first candidate position of first camera 20a calculated by first estimator 13a is sent to first verifier 14a. Data D2b of the second candidate position of second camera 20b calculated by second estimator 13b is sent to second verifier 14b. Data D3b of the third candidate position of third camera 20c calculated by third estimator 13c is sent to third verifier 14c. Data D4b of the fourth candidate position of fourth camera 20d calculated by fourth estimator 13d is sent to fourth verifier 14d.

Verifier 14 calculates the precision degrees of the respective candidate positions of first to fourth cameras 20a to 20d calculated in estimator 13. Specifically, verifier 14 includes first verifier 14a that calculates the precision degree of the first candidate position of first camera 20a, second verifier 14b that calculates the precision degree of the second candidate position of second camera 20b, third verifier 14c that calculates the precision degree of the third candidate position of third camera 20c, and fourth verifier 14d that calculates the precision degree of the fourth candidate position of fourth camera 20d. Incidentally, in addition to the data (any of D1b to D4b) relating to the candidate position, data D1a, D2a, D3a, and D4a that are extracted respectively from the camera images of first to fourth cameras 20a to 20d, map data Dm, and camera mounting position data Dt are input into first to fourth verifiers 14a to 14d. Note that, first to fourth verifiers 13a to 13d may be implemented by four processors provided separately or by time-dividing the processing time with a single processor.

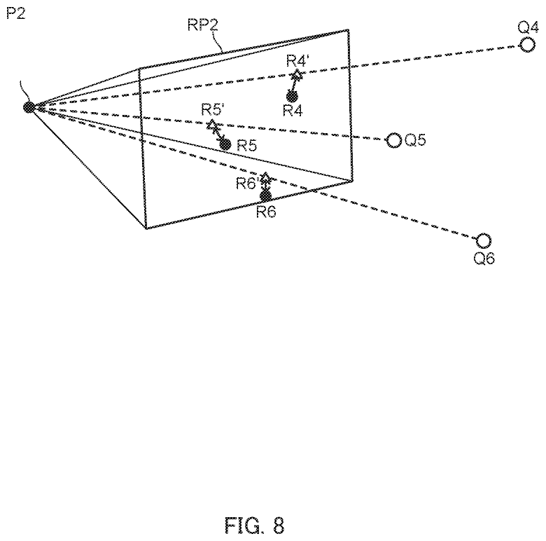

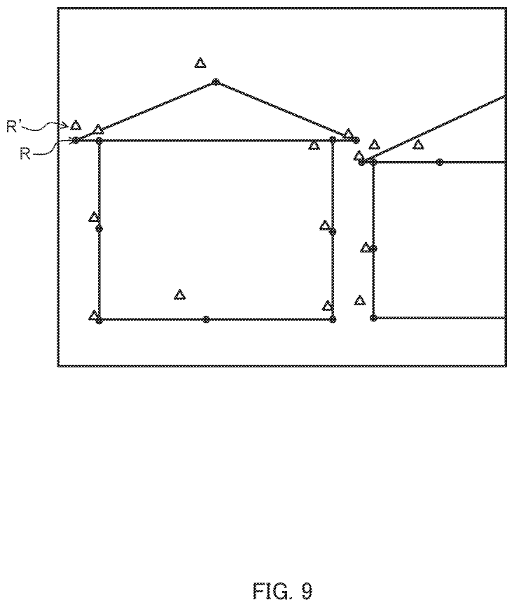

FIGS. 8 and 9 are diagrams for describing processing of first verifier 14a according to the present embodiment.

FIG. 9 illustrates examples of feature points R extracted from the camera image of second camera 20b and projection points R′ resulting from the feature points stored in map data Dm being projected onto the camera image of second camera 20b.

First verifier 14a projects feature point groups stored in map data Dm onto the respective camera images of first to fourth cameras 20a to 20d with reference to the first candidate position of first camera 20a, and thereby calculates the precision degree of the first candidate position of first camera 20a based on a matching degree between the feature point groups projected onto the respective camera images of first to fourth cameras 20a to 20d and the feature point groups extracted respectively from the camera images of first to fourth cameras 20a to 20d.

Details of the processing performed by first verifier 14a are as follows.

First, for example, when it is assumed that first camera 20a is present in the first candidate position, first verifier 14a calculates a virtual position of second camera 20b (point P2 in FIG. 8) from a positional relationship between first camera 20a and second camera 20b that are previously stored in camera mounting position data Dt. Incidentally, the virtual position of second camera 20b is calculated by, for example, performing computing processing relating to a rotational movement and a parallel movement with respect to the first candidate position of first camera 20a, based on the positional relationship between first camera 20a and second camera 20b that are previously stored in camera mounting position data Dt.

Next, first verifier 14a projects respective feature points in the feature point group previously stored in map data Dm (points Q4. Q5, and Q6 in FIG. 8) onto the camera image of second camera 20b (which indicates an imaging plane: the same applies hereinafter) (PR2 of FIG. 8) with reference to the virtual position of second camera 20b, and thereby calculates projection positions of the feature points (points R4′, R5′, and R6′ in FIG. 8) in the camera image of second camera 20b. At this time, first verifier 14a projects, for example, all feature points that can be projected among the feature point group previously stored in map data Dm onto the camera image of second camera 20b, and thus calculates the projected positions thereof.

Next, first verifier 14a matches the feature points stored in map data Dm (points Q4, Q5, and Q6 in FIG. 8), which are projected onto the camera image of second camera 20b with feature points (points R4, R5, and R6 in FIG. 8) to be extracted from the camera image of second camera 20b. This matching process is similar to a publicly known technique, and, for example, feature amount matching processing or the like is used.

Next, with respect to the feature points having been matched with the feature points extracted from the camera image of second camera 20b among the feature point group previously stored in map data Dm, first verifier 14a calculates a re-projection error between the actual positions (positions of points R4, R5, and R6 in FIG. 8) and the projected positions (positions of points R4′, R5′, and R6′ in FIG. 8) (i.e., distance between a projected position and an actual position). In FIG. 8, the distance between point R4 and point R4′, the distance between point R5 and point R5′, and the distance between point R6 and point R6′ each corresponds to the re-projection error.

Next, first verifier 14a counts the number of feature points each having a re-projection error not greater than a threshold value in between with the feature points extracted from the camera image of second camera 20b (hereinafter referred to as “matching point”), among the feature point group previously stored in map data Dm. That is, first verifier 14a grasps, as the number of matching points, a matching degree between the feature point group previously stored in map data Dm, which is projected onto the camera image of second camera 20b, and the feature point group extracted from the camera image of second camera 20b.

In FIG. 9, 15 feature points are extracted from the camera image of second camera 20b, and in the processing of first verifier 14a, for example, among the 15 feature points, the number of feature points which have been matched with the feature points previously stored in map data Dm and each of which has the re-projection error not greater than the threshold value is counted as the matching point.

First verifier 14a then extracts matching points from the camera image of first camera 20a, the camera image of third camera 20c, and the camera image of fourth camera 20d in addition to the camera image of second camera 20b by using the similar technique, and thus counts the number of matching points.

That is, first verifier 14a projects the feature point group stored in map data Dm onto the camera image of first camera 20a with reference to the first candidate position of first camera 20a, and counts the number of feature points each having the re-projection error not greater than the threshold value in between with the feature points extracted from the camera image of first camera 20a, among the feature point group projected onto the camera image of first camera 20a. Further, first verifier 14a projects the feature point group stored in map data Dm onto the camera image of third camera 20c with reference to the first candidate position of first camera 20a, and counts the number of feature points each having the re-projection error not greater than the threshold value in between with the feature points extracted from the camera image of third camera 20c are, among the feature point group projected onto the camera image of third camera 20c. Further, first verifier 14a projects the feature point group stored in map data Dm onto the camera image of fourth camera 20d with reference to the first candidate position of first camera 20a, and counts the number of feature points each having the re-projection error not greater than the threshold value in between with the feature points extracted from the camera image of fourth camera 20d, among the feature point group projected onto the camera image of fourth camera 20d.

Next, first verifier 14a totals the number of matching points extracted respectively from the camera images of first to fourth cameras 20a to 20d and sets the total number as the precision degree of the first candidate position of first camera 20a.

Second verifier 14b, third verifier 14c, and fourth verifier 14d respectively calculate, by the similar technique as in first verifier 14a, the precision degree of the second candidate position of second camera 20b, the precision degree of the third candidate position of third camera 20c, and the precision degree of the fourth candidate position of fourth camera 20d.

Determiner 15 acquires data D1c indicating the precision degree of the first candidate position calculated by first verifier 14a, data D2c indicating the precision degree of the second candidate position calculated by second verifier 14b, data D3c indicating the precision degree of the third candidate position calculated by third verifier 14c, and data D4c indicating the precision degree of the fourth candidate position calculated by fourth verifier 14d. Determiner 15 then adopts a candidate position having the largest precision degree among the first to fourth candidate positions as the most reliable position.

Further, determiner 15 estimates a position of vehicle A in the map space with reference to the candidate position having the largest precision degree among the first to fourth candidate positions. At this time, determiner 15 estimates the position of vehicle A based on, for example, a positional relationship between a camera for the candidate position having the largest precision degree previously stored in camera mounting position data Dt and

the center of gravity vehicle A.

Incidentally, in a case where first to fourth estimators 13a to 13d are each configured to perform repetitive operation for the candidate position, determiner 15 may provide a threshold value of the precision degree (i.e., the number of matching points) so as to specify an end condition of the repetitive computation (see the variation to be described later).

Position estimation apparatus 10 according to the present embodiment enables, with this estimation method, estimating of a position of vehicle A with high accuracy even when a situation occurs where, in any of first to fourth cameras 20a to 20d, a distribution of the feature points in the camera image of the camera and a distribution of the feature points stored in map data Dm are greatly different from each other due to the effect of occlusion or the like.

For example, when the camera image of first camera 20a is different from map data Dm due to the effect of occlusion, the feature points that can be matched with the feature points stored in map data Dm among the feature points extracted from the camera image of first camera 20a are usually limited to feature points far from first camera 20a in many cases. The positional accuracy for such feature points is low, and when estimating the position of first camera 20a based on such the feature points, the accuracy for the position of first camera 20a (i.e., position of vehicle A) is thus also deteriorated.

In this regard, position estimation apparatus 10 according to the present embodiment enables estimating the position of vehicle A using an appropriate feature points having the high positional accuracy among the feature points extracted respectively from first to fourth cameras 20a to 20d; as a result, the accuracy of the positional estimation for vehicle A is also improved.

[Operation of Position Estimation Apparatus]

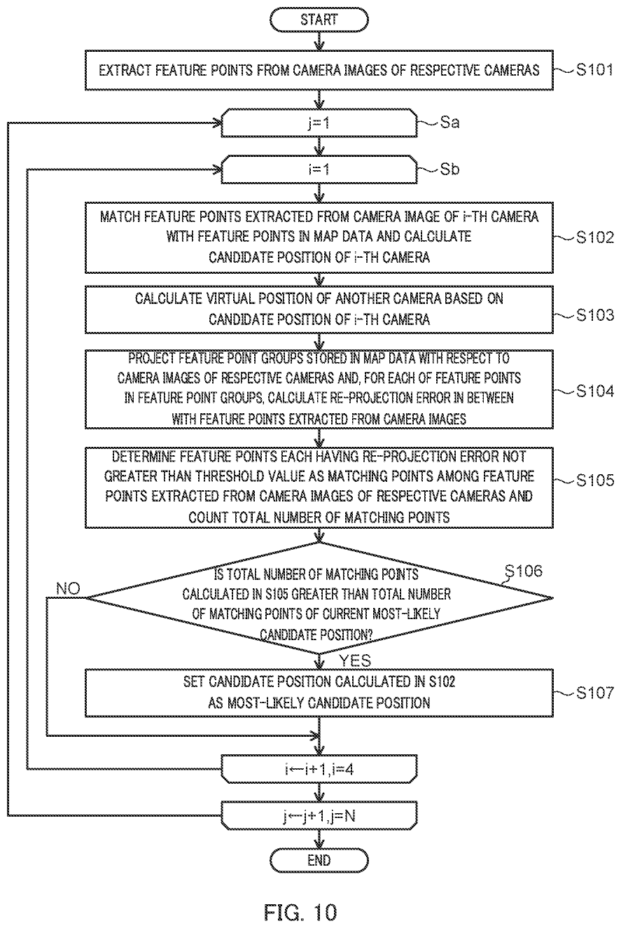

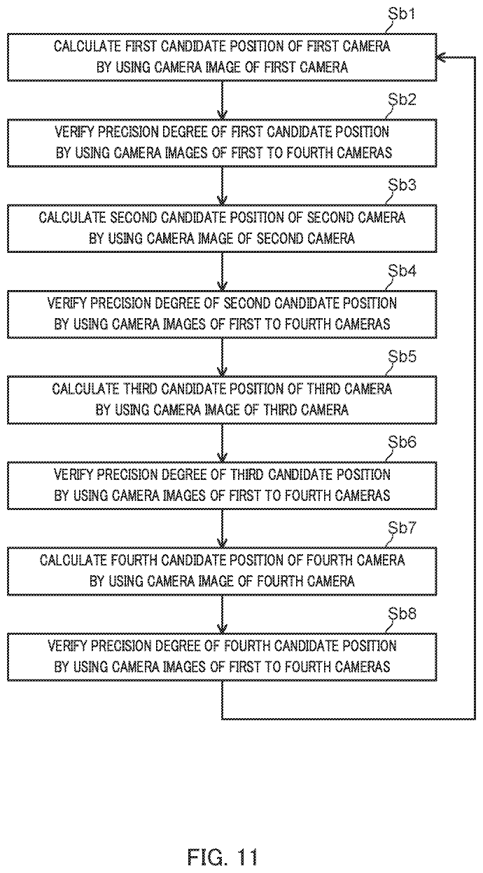

FIG. 10 is a flowchart illustrating an exemplary operation of position estimation apparatus 10 according to the present embodiment. Here, an aspect is illustrated in which each function of position estimation apparatus 10 according to the present embodiment is implemented by a program. FIG. 11 schematically illustrates loop processing in steps Sa and Sb of FIG. 10.

In step S101, position estimation apparatus 10 first extracts feature points respectively from the camera images of first to fourth cameras 20a to 20d.

In step S102, position estimation apparatus 10 matches feature points (e.g., three points) extracted from the camera image of the i-th camera (which indicates any camera of first to fourth cameras 20a to 20d; the same applies hereinafter) with the feature points in map data Dm and thus calculates a candidate position of the i-th camera based on this matching.

In step S103, position estimation apparatus 10 calculates a virtual position of another camera other than the i-th camera among first to fourth cameras 20a to 20d based on the candidate position and camera mounting position data Dt of the i-th camera.

In step S104, position estimation apparatus 10 projects the feature point groups stored in map data Dm with respect to the respective camera images of first to fourth cameras 20a to 20d. Position estimation apparatus 10 then matches each of the feature points in the feature point groups projected onto the respective camera images of first to fourth cameras 20a to 20d with the feature points extracted respectively from the camera images of first to fourth cameras 20a to 20d, and, after the matching, calculates a re-projection error for each of these feature points in these feature point groups.

In step S105, position estimation apparatus 10 determines, based on the re-projection errors calculated in step S104, feature points each having a re-projection error not greater than the threshold value as matching points among the feature points extracted respectively from the camera images of first to fourth cameras 20a to 20d, and thereby counts the total number of the matching points extracted from the respective camera images of first to fourth cameras 20a to 20d.

In step S106, position estimation apparatus 10 determines whether the total number of matching points calculated in step S105 is greater than the total number of matching points of the currently-held most-likely candidate position. In a case where the total number of matching points calculated in the step S105 is greater than the total number of matching points of the currently-held most-likely candidate position (S106: YES), the processing proceeds to step S107 whereas in a case where the total number of matching points calculated in the step S105 is not greater than the total number of matching points of the currently-held most-likely candidate position (S106: NO), the processing returns to step S102 to execute the processing for the next camera (the i+1-th camera).

In step S107, position estimation apparatus 10 returns to step S102 after setting the candidate position calculated in step S102 as the most-likely candidate position and executes the processing for the next camera (the i+1-th camera).

Position estimation apparatus 10 repeatedly executes the processes in the step S102 to the step S107 in loop processing Sa and loop processing Sb. Here, loop processing Sb is a loop for switching the camera subject to the processing (i.e., camera for which a candidate position and the precision degree of the candidate position are calculated) among first to fourth cameras 20a to 20d. Meanwhile, loop processing Sa is a loop for switching feature points used in calculating the candidate positions of respective first to fourth cameras 20a to 20d. In the flowchart of FIG. 10, variable i is a variable (here, an integer of one to four) indicating the camera subject to the processing among first to fourth cameras 20a to 20d, and variable N is a variable (here, an integer of one to N (where N is, for example, 50)) indicating the number of times of switching of the feature points used in calculating one candidate position.

Specifically, as illustrated in FIG. 11, position estimation apparatus 10 repeatedly executes the following steps: step Sb1 for calculating the first candidate position of first camera 20a by using the camera image of first camera 20a; step Sb2 for verifying the precision degree of the first candidate position by using the camera images of first to fourth cameras 20a to 20d: step Sb3 for calculating the second candidate position of second camera 20b by using the camera image of second camera 20b; step Sb4 for verifying the precision degree of the second candidate position by using the camera images of first to fourth cameras 20a to 20d; step Sb5 for calculating the third candidate position of third camera 20c by using the camera image of third camera 20c; step Sb6 for verifying the precision degree of the third candidate position by using the camera images of first to fourth cameras 20a to 20d: step Sb7 for calculating the fourth candidate position of fourth camera 20d by using the camera image of fourth camera 20d; and step Sb8 for verifying the precision degree of the fourth candidate position by using the camera images of first to fourth cameras 20a to 20d.

Position estimation apparatus 10 according to the present embodiment calculates a candidate position of the camera having the highest position accuracy (here, any of first to fourth cameras 20a to 20d) with the processing as described above. Position estimation apparatus 10 then estimates the position of vehicle A by using the candidate position of the camera

[Effects]

Thus, position estimation apparatus 10 according to the present embodiment includes:

estimator 13 that calculates a candidate position of a k-th camera (where k is an integer of one to n) in a map space from among n cameras, based on positions of feature points in an actual view in a camera image and positions of the feature points in the map space previously stored in map data Dm, the feature points in the actual view being extracted from a camera image taken by the k-th camera; and

verifier 14 that projects feature point groups in the actual view onto camera images respectively taken by the n cameras, with reference to the candidate position of the k-th camera, the feature point groups being stored in map data Dm in association with the positions in the map space, and calculates a precision degree of the candidate position of the k-th camera based on matching degrees between the feature point groups projected onto the camera images respectively taken by the n cameras and the feature point groups extracted respectively from the camera images taken by the n cameras,

wherein:

estimator 13 calculates the candidate position for each of first to n-th cameras of the n cameras,

verifier 14 calculates the precision degree of the candidate position of each of the first to n-th cameras of the n cameras, and

a position of a mobile body (e.g., vehicle A) is estimated with reference to the candidate position having a highest precision degree among a plurality of the precision degrees of the candidate positions of the first to n-th cameras of the n cameras.

Thus, a position of a mobile body can be estimated with high accuracy even when a situation occurs where, in any of the plurality of cameras 20a to 20d included in the mobile body (e.g., vehicle A), the camera image taken by the camera and the map data (i.e., distribution of feature points stored in map data) are greatly different from each other due to the effect of occlusion or the like.

In particular, position estimation apparatus 10 according to the present embodiment is advantageous in estimating a mobile body with high accuracy and small computation amount, by using a plurality of cameras, without solving the complicated computation as in NPL 2. Thus, it is possible to estimate the position of the mobile body in real time even in a case of the computation amount is limited as in the on-vehicle environment while the moving speed of the mobile body is fast.

(Variation)

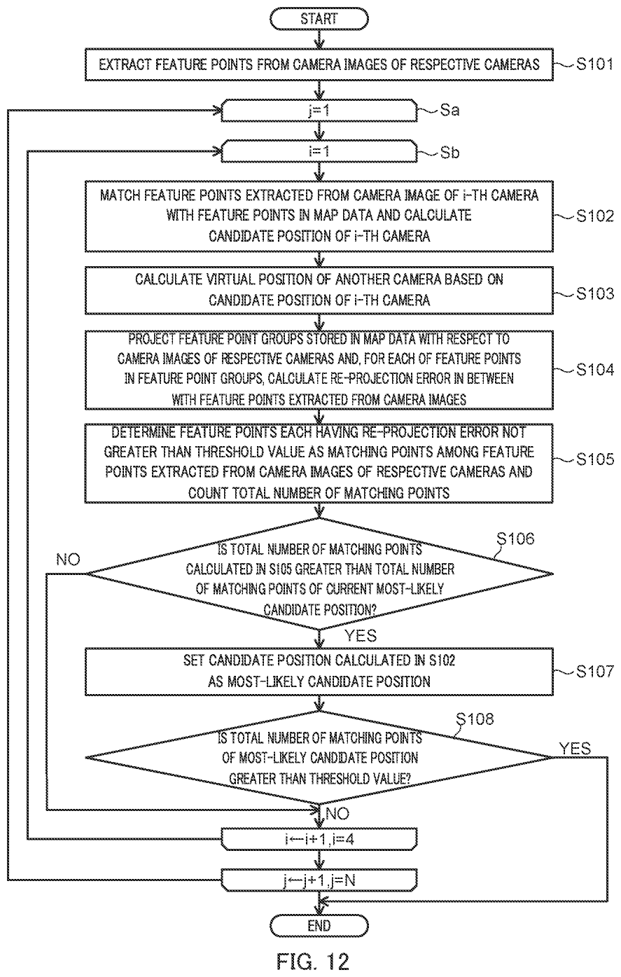

FIG. 12 is a flowchart illustrating an exemplary operation of a position estimation apparatus according to a variation. The flowchart of FIG. 12 is different from the flowchart of FIG. 10 in that the process in step S108 is added after step S107.

In the above embodiment, in order to search for a candidate position with the high positional accuracy as possible, loop processing Sa is executed a predetermined number of times or more. However, from the viewpoint of shortening the time to estimate a position of a mobile body (e.g., vehicle A), the number of times of loop processing Sa execution is preferably small as possible.

From this viewpoint, in the flowchart according to the present variation, in step S108, a process is added of determining whether the total number of matching points calculated in step S105 (i.e., total number of matching points of the most-likely candidate) is greater than the threshold value. Thus, in a case where the total number of matching points calculated in step S105 is greater than the threshold value (S108. YES), the flowchart of FIG. 12 is ended, whereas in a case where the total number of matching points calculated in step S105 is not greater than the threshold value (S108: NO), loop processing Sa and Sb are continued.

As a result, it is possible to shorten the computation time until estimating the position of the mobile body as much as possible while ensuring the estimation accuracy for the position of the mobile body.

### Other Embodiments

The present invention is not limited to the above-described embodiments, and various modified modes may be derived from the above-described embodiments.

For example, although four cameras are shown as examples of cameras mounted on vehicle A in the above embodiment, the number of cameras mounted on vehicle A is optional as long as it is two or more. Additionally, a capturing area of each of the cameras may be a frontward, rearward, or omni-directional area of vehicle A, and the capturing areas of the plurality of cameras may overlap each other. The cameras mounted on vehicle A may be fixed or movable.

Moreover, although vehicle A is shown as an example of a mobile body to which position estimation apparatus 10 is applied in the above embodiment, the type of the mobile body is optional. The mobile body to which position estimation apparatus 10 is applied may be a robot or a drone.

Furthermore, although the functions of position estimation apparatus 10 are implemented by processing of CPU 101 in the above embodiments, some or all of the functions of position estimation apparatus 10 may alternatively be implemented by, in place of or in addition to processing of CPU 101, processing of a digital signal processor (DSP) or a dedicated hardware circuit (e.g., an application-specific integrated circuit (ASIC) or a field-programmable gate array (FPGA)).

Although specific examples of the present disclosure have been described in detail above, these are merely illustrative and do not limit the scope of the claims. The art described in the claims includes various modifications and variations of the specific examples illustrated above.

The disclosure of Japanese Patent Application No. 2019-211243, filed on Nov. 22, 2019 including the specification, drawings and abstract, are incorporated herein by reference in its entirety.

### INDUSTRIAL APPLICABILITY

The position estimation apparatus according to the present disclosure can improve the estimation accuracy for a position and a posture of a mobile body with a small computation load.

### REFERENCE SIGNS LIST

A Vehicle
10 Position estimation apparatus
11 Acquirer
12 Feature point extractor
13 Estimator
14 Verifier
15 Determiner
20a, 20b, 20c, 20d Camera
30 Vehicle ECU
40 Vehicle drive apparatus
Dm Map data
Dt Camera mounting position data

1. A position estimation apparatus for a mobile body including n cameras (where n is an integer of two or more) for capturing an actual view of surroundings, the position estimation apparatus comprising:
an estimator that calculates a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and
a verifier that projects feature point groups in the actual view onto camera images respectively taken by the n cameras, with reference to the candidate position of the k-th camera, the feature point groups being stored in the map data in association with the positions in the map space, and calculates a precision degree of the candidate position of the k-th camera based on matching degrees between the feature point groups projected onto the camera images respectively taken by the n cameras and the feature point groups extracted respectively from the camera images taken by the n cameras,
wherein:
the estimator calculates the candidate position for each of first to n-th cameras of the n cameras,
the verifier calculates the precision degree of the candidate position of each of the first to n-th cameras of the n cameras, and
a position of the mobile body is estimated with reference to the candidate position having a highest precision degree among a plurality of the precision degrees of the candidate positions of the first to n-th cameras of the n cameras.

2. The position estimation apparatus according to claim 1, wherein the verifier calculates a number of the feature points each having a re-projection error not greater than a threshold value among the feature point groups, as the precision degree of the candidate position of the k-th camera.

3. The position estimation apparatus according to claim 1, wherein the mobile body is a vehicle.

4. The position estimation apparatus according to claim 1, wherein the n cameras respectively capture areas different from each other in the actual view.

5. The position estimation apparatus according to claim 1, wherein:
the estimator calculates a plurality of the candidate positions of the k-th camera by changing the feature points used for calculating the candidate position among a plurality of the feature points extracted from the camera image taken by the k-th camera,
the verifier calculates the precision degree for each of the plurality of candidate positions of the k-th camera, and
the position of the mobile body is estimated with reference to the candidate position having the highest precision degree among the plurality of the precision degrees of the plurality of the candidate positions of each of the first to n-th cameras of the n cameras.

6. A vehicle, comprising the position estimation apparatus according to claim 1.

7. A position estimation method for a mobile body including n cameras (where n is an integer of two or more) for capturing an actual view of surroundings, the position estimation method comprising:
calculating a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and
projecting feature point groups in the actual view onto camera images respectively taken by the n cameras, with reference to the candidate position of the k-th camera, the feature point groups being stored in the map data in association with the positions in the map space, and calculating a precision degree of the candidate position of the k-th camera based on matching degrees between the feature point groups projected onto the camera images respectively taken by the n cameras and the feature point groups extracted respectively from the camera images taken by the n cameras,
wherein:
in the calculating of the candidate position, the candidate position is calculated for each of first to n-th cameras of the n cameras,
in the projecting of the feature point groups and the calculating of the precision degree, the precision degree of the candidate position of each of the first to n-th cameras of the n cameras is calculated, and
a position of the mobile body is estimated with reference to the candidate position having a highest precision degree among a plurality of the precision degrees of the candidate positions of the first to n-th cameras of the n cameras.

8. A position estimation program causing a computer to estimate a position of a mobile body including n cameras (where n is an integer of two or more) for capturing an actual view of surroundings, the position estimation program comprising:
calculating a candidate position of a k-th camera (where k is an integer of one to n) in a map space from among the n cameras, based on positions of feature points in the actual view in a camera image and positions of the feature points in the map space previously stored in map data, the feature points in the actual view being extracted from a camera image taken by the k-th camera; and
projecting feature point groups in the actual view onto camera images respectively taken by the n cameras, with reference to the candidate position of the k-th camera, the feature point groups being stored in the map data in association with the positions in the map space, and calculating a precision degree of the candidate position of the k-th camera based on matching degrees between the feature point groups projected onto the camera images respectively taken by the n cameras and the feature point groups extracted respectively from the camera images taken by the n cameras,
wherein:
in the calculating of the candidate position, the candidate position is calculated for each of first to n-th cameras of the n cameras,
in the projecting of the feature point groups and the calculating of the precision degree, the precision degree of the candidate position of each of the first to n-th cameras of the n cameras is calculated, and
a position of the mobile body is estimated with reference to the candidate position having a highest precision degree among a plurality of the precision degrees of the candidate positions of the first to n-th cameras of the n cameras.
